(19) United States
(12) Patent Application Publication
(10) Pub. No.: US 2009/0008427 A1
(43) Pub. Date: Jan. 8, 2009

(54) Driving unit of welding equipment

(76) Inventor: Yoshio Sato, Ayase-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/215,820

(22) Filed: Jun. 30, 2008

(30) Foreign Application Priority Data
Jul. 2, 2007 (JP) 2007-173891

(51) Int. Cl. B23K 37/047

(52) U.S. Cl. 228/45

(57) ABSTRACT

There is provide a driving unit of welding equipment capable of surely stopping turning of a pressure application shaft while shortening the entire length of welding equipment without enlarging a hole diameter of a rotary shaft of a motor, thereby rendering a welding gun small-sized, lightweight and compact as a whole. The driving unit of welding equipment provided with the pressure application shaft that is driven by the motor and has a portion to be drawn into the motor, wherein the rotary shaft of the motor is formed of a hollow shaft, a screw shaft is fixed to the rotary shaft, and a nut to be threaded with the screw shaft is provided in the pressure application shaft, characterized in that the pressure application shaft is formed of a ball spline shaft and a part or whole of a ball spline bearing is housed in the rotary shaft.

### FIELD OF THE INVENTION

The invention relates to a driving unit of welding equipment provided with a pressure application shaft that is driven by a motor and has a portion to be drawn into the motor, wherein a rotary shaft of the motor is formed of a hollow shaft, a screw shaft is fixed to the rotary shaft, and a nut to be threaded with the screw shaft is provided in the pressure application shaft.

### BACKGROUND OF THE INVENTION

There has been conventionally a driving unit of welding equipment provided with a pressure application shaft that is driven by a motor and has a portion to be drawn into the motor, wherein a rotary shaft of the motor is formed of a hollow shaft, a screw shaft is fixed to the rotary shaft, and a nut to be threaded with the screw shaft is provided in the pressure application shaft, for example, as disclosed in JP 2001-293577A.

However, in the conventional driving unit of welding equipment, a so-called LM guide mechanism is utilized as a mechanism for stopping turning (hereinafter referred to as turning stop mechanism) of the pressure application shaft provided with the nut, and a bearing constituting a guide rail for covering an outer ring of the pressure application shaft is provided wherein if the bearing does not cover the pressure application shaft ranging over the whole moving area (stroke area) of the pressure application shaft, operational balls of the bearing will come off from a guide rail, thereby rendering a diameter of the turning stop mechanism of the pressure application shaft large. Since the LM guide mechanism is disposed inside the rotary shaft, a hole diameter of the rotary shaft becomes large, rendering the motor body large, resulting in large moment of inertia of the rotary shaft so that a instantaneous force to be followed up when forming a nugget becomes small, thereby deteriorating the performance of welding equipment. Further, a sectional area of the hollow motor becomes large, and hence a welding gun becomes large as a whole, resulting in danger of being contrary to the needs from the market requiring lightweight and compact welding gun.

### SUMMARY OF THE INVENTION

The invention has been developed in view of the problems of the conventional technique and it is an object of the invention to provide a driving unit of welding equipment capable of surely stopping turning of the pressure application shaft while shortening the entire length of welding equipment without enlarging the hole diameter of the rotary shaft of the motor, thereby rendering a welding gun small-sized, lightweight and compact as a whole.

To achieve the above object, the driving unit of welding equipment provided with a pressure application shaft that is driven by a motor and has a portion to be drawn into the motor, wherein a rotary shaft of the motor is formed of a hollow shaft, a screw shaft is fixed to the rotary shaft, and a nut to be threaded with the screw shaft is provided in the pressure application shaft, characterized in that the pressure application shaft is formed of a ball spline shaft and a part or whole of a bearing of the ball spline shaft (hereinafter referred to as a ball spline bearing) is housed in the rotary shaft.

With the driving unit of welding equipment having the foregoing configuration, it surely stops turning of the pressure application shaft while shortening the entire length of welding equipment without enlarging the hole diameter of the rotary shaft of the motor, thereby rendering a welding gun small-sized, lightweight and compact as a whole, and hence particularly it is effective as a driving unit for applying a pressure eccentrically relative to the pressure application shaft.

### BRIEF DESCRIPTION OF THE DRAWINGS

FIG. 1 is a longitudinal sectional view of a driving unit of welding equipment of the invention, and

FIG. 2 is a front view of the driving unit of welding equipment in FIG. 1.

### PREFERRED EMBODIMENT OF THE INVENTION

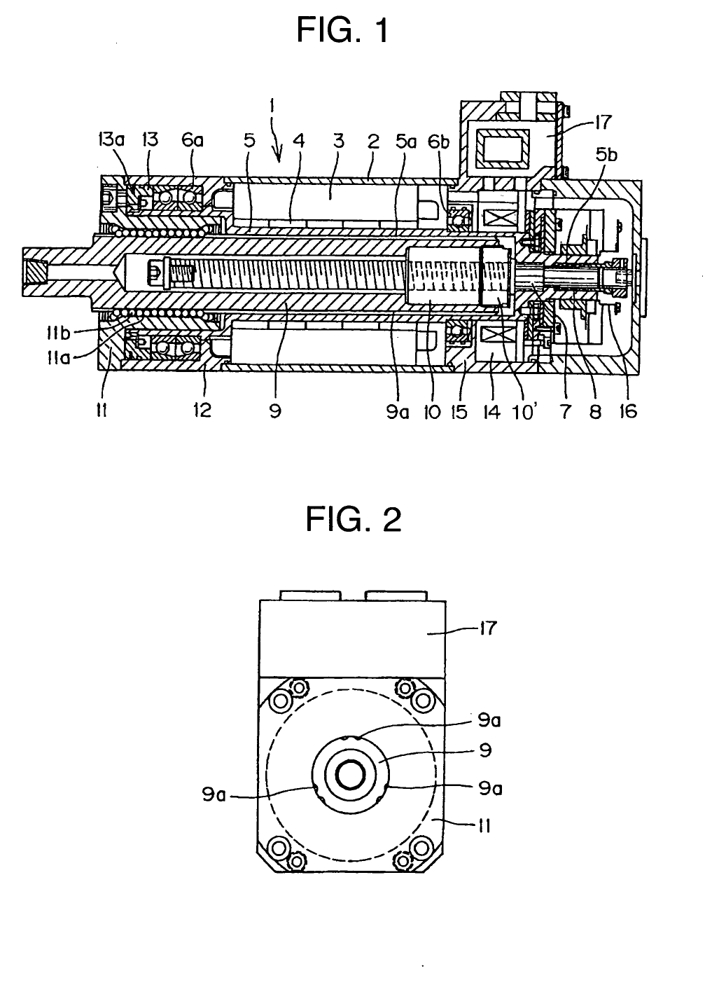

An embodiment of the invention is now described with reference to FIG. 1 and FIG. 2.

In these figures, depicted by 1 is a servomotor 1, and the servomotor 1 comprises a stator winding 3 fixed to an outer shell 2 thereof, rotor poles 4 disposed on the inner periphery of the stator winding 3, and a rotary shaft 5 onto which the rotor poles 4 are fixed, wherein the rotary shaft 5 comprises a large diameter hollow part 5a and a small diameter hollow part 5b. The rotary shaft 5 is journalled by the outer shell 2 of the servomotor 1 via bearings 6a and 6b. Further, a ball screw 7 positioned at the shaft core part of the servomotor 1 is fixed to the small diameter hollow part 5b of the rotary shaft 5 by fixing means 8 such as a wedge and so forth. The bearing 6a is formed of an angular bearing.

Depicted by 9 is a pressure application shaft. A ball nut 10, which has a screw to mesh indirectly with the screw of the screw shaft 7 via balls, not shown, is threadably attached and fixed to a rear part of the pressure application shaft 9 at a screwing part 10′. Further, the front part of the pressure application shaft 9 can be protruded from the servomotor 1 and a front end part of the pressure application shaft 9 can be connected to an electrode (not shown) for applying a pressure to a workpiece to weld the workpiece in the case of a C-type welding gun, and to a connection member (not shown) for connecting it to a gun arm in the case of an X-type welding gun. In the case where the screw shaft 7 is formed of a normal screw shaft, the ball nut 10 may be formed of a normal nut whereby both may be meshed with each other, or the pressure application shaft 9 and the ball nut 10 may be configured by integral molding without integrating them by use of threading means.

Further, an outer diameter of the pressure application shaft 9 is smaller than an inner diameter of the large hollow part 5a of the hollow rotary shaft 5, and recessed ball spline grooves 9a, 9a . . . are formed on the outer peripheral surface of the pressure application shaft 9 at multiple spots (e.g. three spots) along the shaft center of the pressure application shaft 9 and they serve as a turning stop mechanism.

Depicted by 11 is a ball spline bearing fixed to a front wall 12 of the servomotor 1 and is housed in the rotary shaft 5 as a bearing of the pressure application shaft 9 while extended from the front wall 12, and ball receive passages 11a are formed on the inner surface of the ball spline bearing 11 at the position opposite to the recessed ball spline grooves 9a, 9a . . . to serve for stopping turning of the pressure application shaft 9. A part of the ball spline bearing 11 may be protruded toward the front of the rotary shaft 5.

A ring-shaped holding member 13 for pressing and holding the outer ring of the angular bearing 6a is screwed on an outer peripheral part of the ball spline bearing 11 and a cutting groove 13a is formed on the holding member 13 by which a spring action effect is generated to supply the angular bearing 6a with a precompression.

Depicted by 14 is a hollow brake body for regulating the rotation of the rotary shaft 5 of the servomotor 1, and it is mounted on the outer peripheral end side of the large hollow part 5a of the rotary shaft 5 while penetrating it and fixed to a rear wall 15 of the servomotor 1. Depicted by 16 is a position detector and 17 is a conductive connector to be connected to the servomotor 1 and the position detector 16.

With the driving unit of welding equipment having the foregoing configuration, FIG. 1 and FIG. 2 show the state where the pressure application shaft 9 is most drawn into the rotary shaft 5 of the servomotor 1. In the case where the pressure application shaft 9 is allowed to be protruded from the servomotor 1 from this state to implement pressure application operation, for example, a three-phase AC is supplied to the stator winding 3 of the servomotor 1 so that the rotor poles 4 are energized to rotate the rotary shaft 5. As a result, the ball screw shaft 7 fixed to the rotary shaft 5 is turned, and the ball nut 10 is moved along the ball screw shaft 7 with the turning of the ball screw shaft 7 so that the pressure application shaft 9 integrated with the ball nut 10 is moved on the inner peripheral surface of the rotary shaft 5 while guided and stopped in turning by the ball spline bearing 11. As a result, the pressure application shaft 9 is subsequently protruded outward from the servomotor 1, thereby implementing the pressure application operation while increasing the amount of protrusion from the servomotor 1.

When the pressure application shaft 9 is moved while it is guided by the ball spline bearing 11, balls 11b are always circulated in the ball spline bearing 11 to implement the turning stop operation of the pressure application shaft 9 because the ball spline grooves 9a, 9a . . . provided at the side of the pressure application shaft 9 penetrate the ball spline bearing 11.

Since the turning stop mechanism of the pressure application shaft 9 is configured by merely forming the ball spline grooves 9a, 9a . . . on the outer surface at the side of the pressure application shaft 9 and the ball spline bearing 11 is disposed in the front wall 12 with room while avoiding the rotor poles 4 so that the conventional factor to increase the hollow hole diameter of the rotary shaft 5 is eliminated, thereby implementing reliable stop of turning of the pressure application shaft while shortening the entire length of welding equipment without enlarging the hole diameter of the rotary shaft 5 of the motor, so that the welding gun is rendered small-sized, lightweight and compact as a whole. The turning stop mechanism of the pressure application shaft 9 effectively operates as a driving unit for applying a pressure eccentrically relative to the pressure application shaft 9.

Meanwhile, although the motor is explained with reference to the servomotor, the motor may be an appropriate motor, for example, a well known motor such as a stepping motor, inverter motor, reluctance motor and so forth.

What is claimed is:

1. A driving unit of welding equipment provided with a pressure application shaft that is driven by a motor and has a portion to be drawn into the motor, wherein a rotary shaft of the motor is formed of a hollow shaft, a screw shaft is fixed to the rotary shaft, and a nut to be threaded with the screw shaft is provided in the pressure application shaft, characterized in that the pressure application shaft is formed of a ball spline shaft and a part or whole of a ball spline bearing is housed in the rotary shaft.
